(19) United States
(12) Patent Application Publication
(10) Pub. No.: US 2007/0082546 A1
(43) Pub. Date: Apr. 12, 2007

(54) Compression tool for compression connector

(76) Inventor: Shawn Chawgo, Liverpool, NY (US)

Correspondence Address: PASTEL LAW FIRM;CHRISTOPHER R. PASTEL, 8 PERRY LANE, ITHACA, NY, 14850-9267, US

(21) Appl. No.: 11/246,603

(22) Filed: Oct. 7, 2005

(51) Int. Cl. H01R 9/05

(52) U.S. Cl. 439/585

(57) ABSTRACT

A compression tool for connecting a coaxial cable compression connector to a coaxial cable include first and second operating arms rotatably connected at a pivot point, similar to a pair of pliers. Each operating arm includes a handle at one end, but the first arm includes a holding jaw at the other end, while the second arm includes a compression jaw at the other end. The jaws are parallel to each other at the start of the compression stroke, but as the jaws compress the connector parts, one jaw toes-in with respect to the other. To ensure that the jaws apply a compression force primarily along the connector body axis during the compression stroke, the holding jaw is designed to hold the connector end loosely such that the connector end angularly floats within the jaw.

### FIELD OF THE INVENTION

This invention relates generally to the field of compression tools for installing compression connectors onto coaxial cables. More specifically, the present invention relates to an easy to manufacture, inexpensive compression tool with jaws which do not remain parallel throughout the compression stroke.

### BACKGROUND OF THE INVENTION

A number of connectors are available to terminate a coaxial cable so as to connect the cable to various electronic devices, such as switches, distribution boxes, manifolds, and electronic devices. In a typical coaxial cable network, a “drop” cable is used to carry the signal, which may include analog or digital TV signal, internet signal, security monitoring signal, etc., from the rigid coaxial cable near the road to the end user's home. In the current drop connector industry a number of compression tools of various designs are used to compress cable connectors when installing the connector on the coaxial cable. There are several interfaces and types of connectors used, including RCA, “F”, BNC, IEC, etc. One example of a cable-specific cable connector is CMP series compression cable connector made by PPC Corporation, disclosed in U.S. Pat. No. 5,470,257 which is incorporated herein by reference in its entirety.

Many of the existing compression tools compress cable connectors from each end. Since it is not always possible or preferable to push on the connector from the end of the connector, some compression tools known in the art are designed to grip the body of the connector from the side. The compression tools known in the art are designed so that their jaws remain parallel to each other throughout the entire compression range or compression stroke, as disclosed, for example, in U.S. Pat. No. 5,845,393 and 6,112,404 and U.S. Pat. application Ser. No. 2003/0066186. U.S. Pat. No. 6,272,738 discloses another complex hand operated press for installing cable connectors. Two die sets with an identical structure are provided and correspondingly disposed in the compression parts of the handle bars, while two optional die blocks are fitted to the two die holders. The pivot pins are used to hold both the base and the die holder to the handles. Additionally, a guide rod and a coil spring are provided between the die holders which have corresponding guide holes. These prior art compression tools are complex and expensive, and may require periodic tuning and servicing or repair.

Considering that the connectors in many cases have to be installed in the field and in inclement weather conditions, there is a need for a simplified, rugged, inexpensive, and reliable compression tool for compressing cable connectors.

### SUMMARY OF THE INVENTION

Briefly stated, a compression tool for connecting a coaxial cable compression connector to a coaxial cable include first and second operating arms rotatably connected at a pivot point, similar to a pair of pliers. Each operating arm includes a handle at one end, but the first arm includes a holding jaw at the other end, while the second arm includes a compression jaw at the other end. The jaws are parallel to each other at the start of the compression stroke, but as the jaws compress the connector parts, one jaw toes-in with respect to the other. To ensure that the jaws apply a compression force primarily along the connector body axis during the compression stroke, the holding jaw is designed to hold the connector end loosely such that the connector end angularly floats within the jaw.

According to an embodiment of the invention, a compression tool for fitting a compression cable connector onto a coaxial cable includes two crosswise rotatably interconnected operating arms each having a handle at one end and a jaw at another end; the jaws including means for engaging and holding the cable connector in axial alignment with the cable such that the jaws are parallel to each other prior to a compression stroke of the compression tool and such that the cable connector angularly floats within one jaw during the compression stroke of the compression tool, thereby compressing the cable connector onto the coaxial cable in an axial direction of the cable connector.

According to an embodiment of the invention, a compression tool for fitting a compression cable connector onto a coaxial cable includes first and second crosswise rotatably interconnected operating arms; the first operating arm including a first handle at one end and a first jaw at another end; the second operating arm including a second handle at one end and a second jaw at another end; the first jaw including a first cavity sized to permit the coaxial cable to fit therethrough; the second jaw including a second cavity and a lip around part of the second cavity; a space between the lip and a ridge of the cable connector; the lip loosely holding a portion of the cable connector such that during a compression stroke of the compression tool, the space permits the cable connector to angularly float within the second jaw such that the first jaw compresses the cable connector onto the coaxial cable in an axial direction of the cable connector.

According to an embodiment of the invention, a method for making a compression tool for fitting a compression cable connector onto a coaxial cable includes the steps of (a) making first and second operating arms, wherein the first operating arm includes a first handle at one end and a first jaw at another end, while the second operating arm includes a second handle at one end and a second jaw at another end, wherein the first jaw includes a first cavity sized to permit the coaxial cable to fit therethrough, while the second jaw includes a second cavity and a lip around part of the second cavity, wherein a space is formed between the lip and a ridge of the cable connector when the cable connector is fitted into the compression tool; with the lip loosely holding a portion of the cable connector such that during a compression stroke of the compression tool, the cable connector angularly floats within the second jaw such that the first jaw compresses the cable connector onto the coaxial cable in an axial direction of the cable connector; and (2) rotatably interconnecting the operating arms crosswise about a pivot point.

According to an embodiment of the invention, a method for using a compression tool for fitting a compression cable connector onto a coaxial cable includes the steps of (a) providing the compression tool wherein the compression tool includes two crosswise rotatably interconnected operating arms each having a handle at one end and a jaw at another end; (b) engaging and holding the cable connector between the jaws in axial alignment with the cable such that the jaws are parallel to each other prior to a compression stroke of the compression tool and a space is formed between a lip of one jaw and a ridge of the cable connector such that the cable connector angularly floats within one jaw during the compression stroke of the compression tool; and (c) compressing the cable connector onto the coaxial cable with the compression tool in an axial direction of the cable connector.

### BRIEF DESCRIPTION OF THE DRAWINGS

FIG. 1 shows a perspective view of a compression tool according to an embodiment of the invention.

FIG. 2 shows a perspective exploded view of a compression tool according to an embodiment of the invention.

FIG. 3 shows a side elevation view of a compression tool according to an embodiment of the invention.

FIG. 4 shows a front elevation view of a compression tool with a cable connector and coaxial cable according to an embodiment of the invention.

FIG. 5 shows a perspective view of the cable connector held by the compression tool of FIG. 4, with the cable connector in the uninstalled (uncompressed) position ready to be installed onto the cable by the compression tool of FIG. 4.

FIG. 6 shows a perspective view of the cable connector held by the compression tool of FIG. 5 with the cable connector installed (compressed) onto the cable.

### DETAILED DESCRIPTION OF THE PREFERRED EMBODIMENT

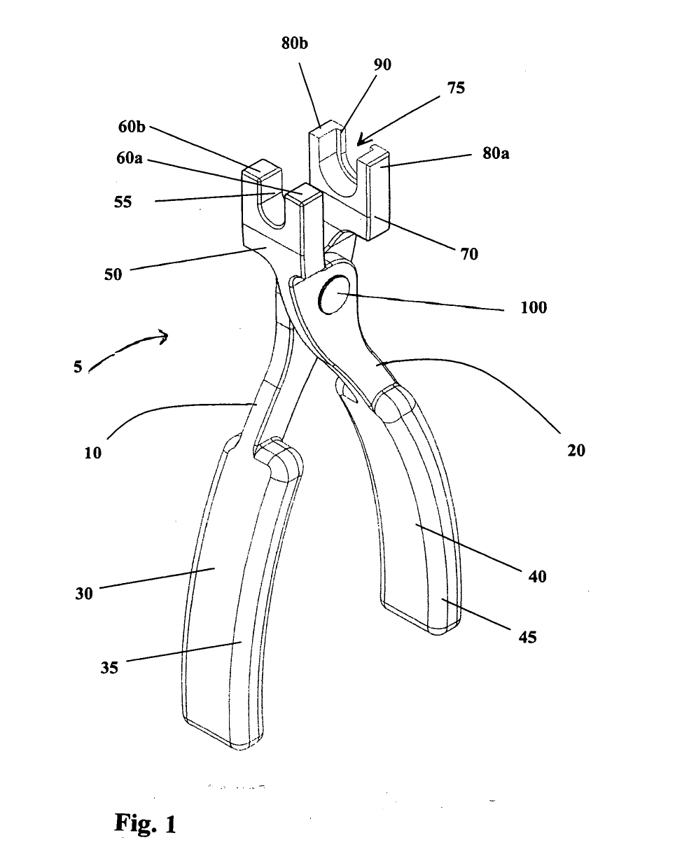

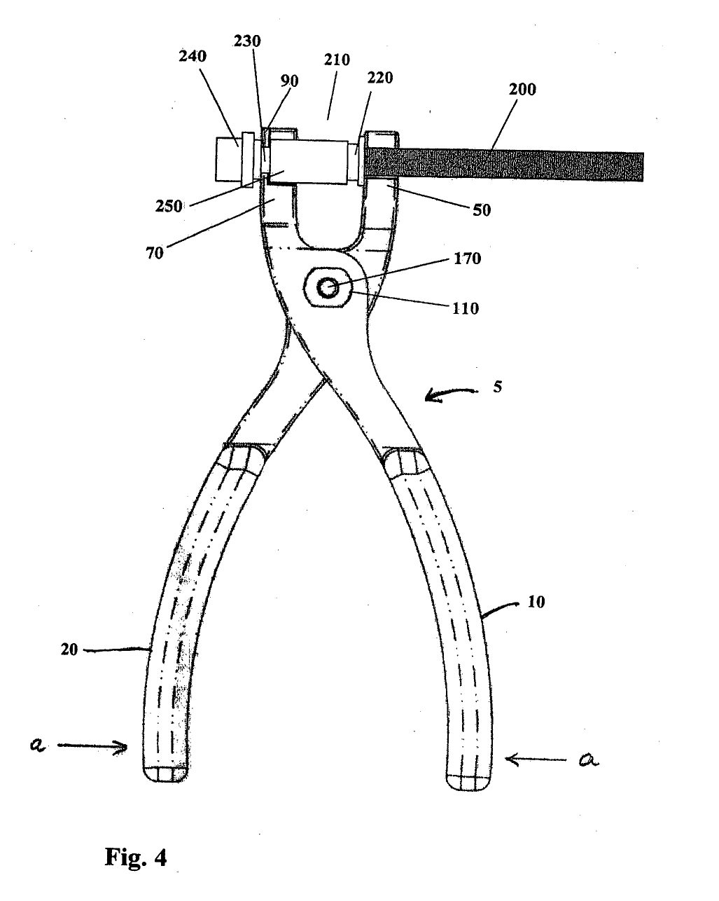

Referring to FIG. 1, a compression tool 5 according to an embodiment of the present invention is shown. Compression tool 5 includes operating arms 10 and 20, with operating arm 10 including a handle 30 at one end and a holding jaw 70 at the other end, while operating arm 20 includes a handle 40 at one end and a compression jaw 50 at the opposite end. Each jaw 50, 70 is formed roughly in the shape of a two-pronged fork, with compression jaw 50 formed by prongs 60a and 60b with a cavity 55 between prongs 60a, 60b, while holding jaw 70 is formed by prongs 80a and 80b with a cavity 75 between prongs 80a, 80b. Handles 30 and 40 of operating arms 10 and 20 optionally have rubberized or plastic grips 35 and 45 to improve the convenience of operating compression tool 5 by hand. Grips 35 and 45 are preferably formed by vinyl dipping. Operating arms 10, 20 are preferably one-piece and made of a material having sufficient strength, i.e., without permanent deformation of operating arms 10 and 20, to form a compression fit between a compression connector 210 (FIG. 4) and a coaxial cable (FIG. 4).

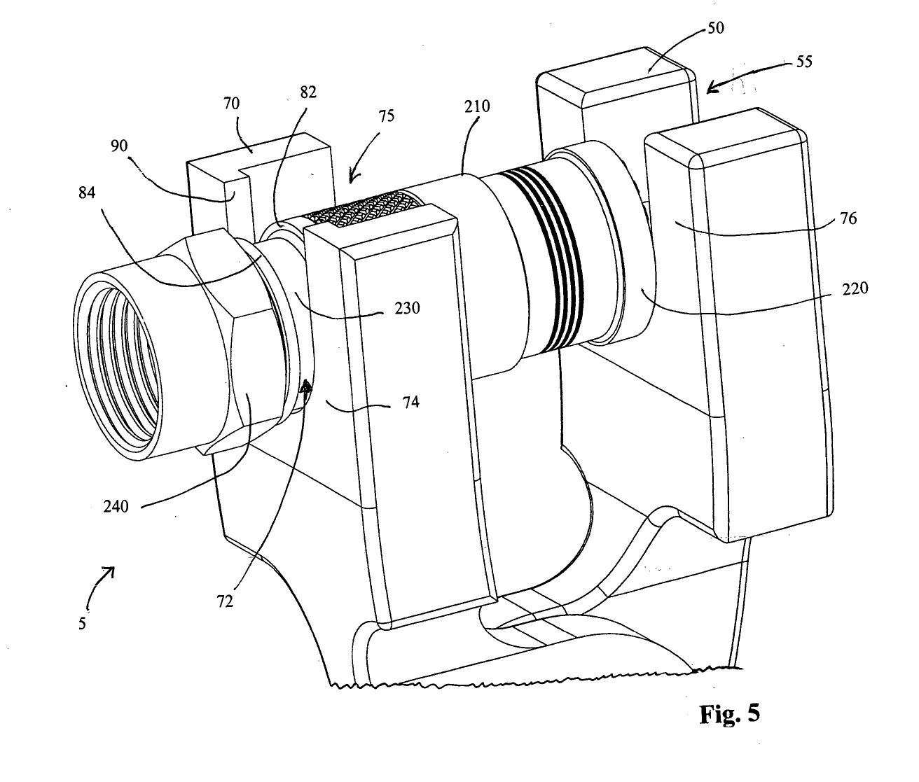

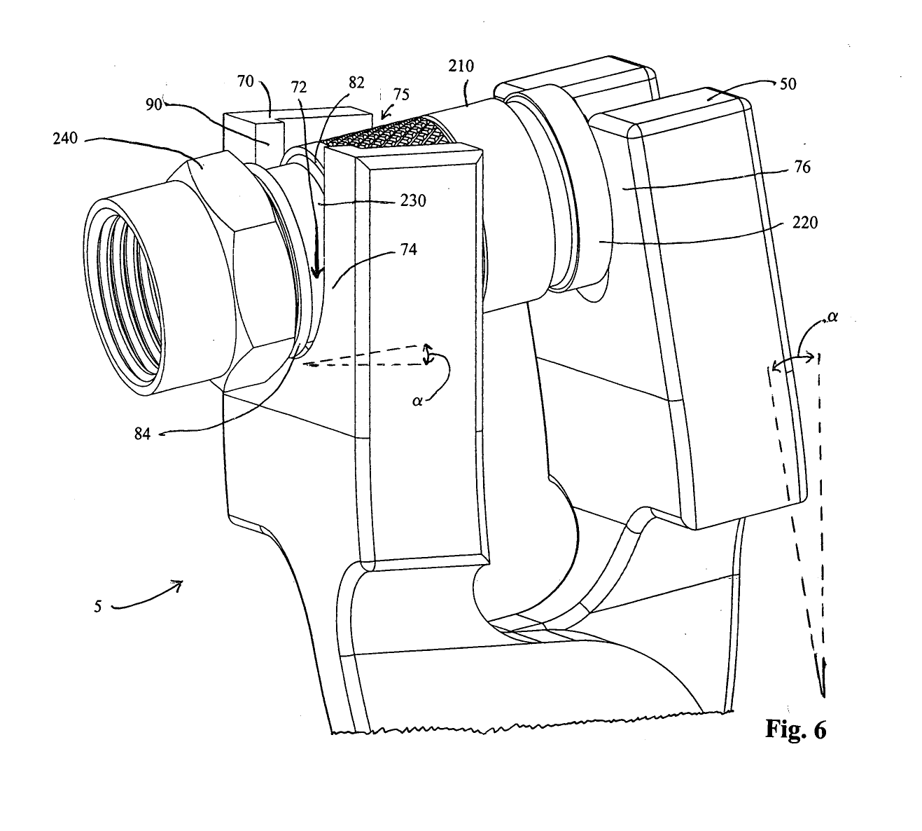

Operating arms 10 and 20 are set crosswise against each other with compression jaw 50 of operating arm 20 and holding jaw 70 of operating arm 10 facing each other and their corresponding handles 30 and 40 facing each other. Operating arms 10, 20 are rotatably joined together by a fastener such as a bolt 100. Operating arms 10, 20 can move towards each other around bolt 100 which acts as a pivot point when an operator moves handles 30 and 40 together which causes compression jaw 50 and holding jaw 70 to move towards each other. Holding jaw 70 includes a lip 90 along an edge of cavity 75 furthest away from compression jaw 50. Lip 90 is preferably sized to engage a coaxial cable connector (FIGS. 5-6) and to loosely hold the cable connector during the compression stroke of compression tool 5 and to prevent axial movement of the cable connector. Cavity 55 of compression jaw 50 is preferably sized so as to accommodate a coaxial cable 200 (FIG. 4) with a coaxial cable connector 210 (FIG. 4) ) placed thereon for attachment to coaxial cable 200.

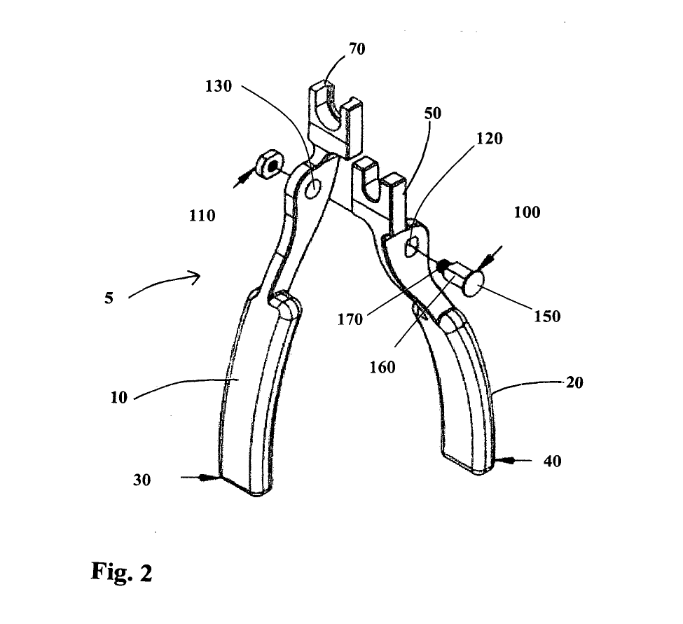

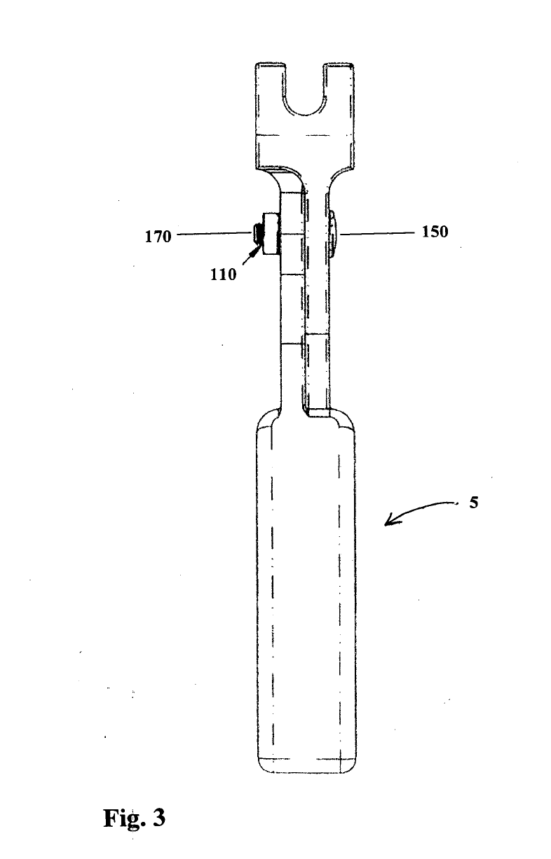

Referring now to FIGS. 2-3, the exploded perspective view illustrates the assembly of compression tool 5, wherein operating arms 10, 20 are set crosswise against each other with matching holes 130 and 120 aligned. A fastener such as bolt 100 with a bolt head 150, a non-threaded bolt area 160, and a threaded bolt area 170, is inserted through aligned holes 130 and 120, after which a nut 110 is threaded on threaded bolt area 170 to complete the assembly of compression tool 5. It can be appreciated from FIG. 2 that operating arms 10, 20 and jaws 50, 70 of compression tool 5 are able to move in relation to each other by rotating around an axis represented by bolt 100 when handles 30, 40 of compression tool 5 are compressed together or moved apart by the operator's hand.

Referring now to FIGS. 4-5, connector 210 is placed between compression jaw 50 and holding jaw 70 prior to the compression stroke. Coaxial cable 200 is shown pre-inserted into cable connector 210 through a compression sleeve 220, with exposed coaxial cable 200 inserted into cavity 55 of compression jaw 50 (FIG. 1). Lip 90 of holding jaw 70 engages a ridge 82 of cable connector 210 at a neck 230 situated between a connector nut 240, which is typically rotatably connected to neck 230, and a connector main body 250. Holding jaw 70 and lip 90 are loosely holding cable connector 210 so that some angular movement of connector 210 with respect to holding jaw 70 is possible. Compression jaw 50 engages an end of compression sleeve 220, ready to push compression sleeve 220 into cable connector main body 250 to cause a compression fit between compression sleeve 220 and coaxial cable 200.

Compression tool 5 is shown in FIGS. 4-5 in the position just prior to the compression stroke. A face 76 of compression jaw 50 and a face 74 of holding jaw 70 are parallel to each other at this time. Compression cable connector 210 and coaxial cable 200 are axially aligned and held together by compression jaw 50 and holding jaw 70. The plane of the end of compression sleeve 220 is parallel to the plane of face 76 of compression jaw 50. Neck 230 of cable connector 210 is defined by ridge 82 and a ridge 84 of connector nut 240. The planes of ridge 82 and ridge 84 are parallel to the plane of face 74 of holding jaw 70, with a space 72 between lip 90 and ridge 84. The compression stroke is initiated by the operator's hand pressing on handles 10, 20 of compression tool 5 as indicated by force arrows a with handles 10, 20 moving towards each other and jaws 50 and 70 moving towards each other, thus pushing compression sleeve 220 into connector main body 250.

Referring to FIG. 6, jaws 50, 70 have moved closed to each other, with the plane of face 76 of compression jaw 50 now at an angle α to the plane of face 74 of holding jaw 70. Because of the toe-in of jaws 50 and 70 during the compression stroke, the initial parallel alignment of face 76 of jaw 50 and face 74 of jaw 70 changes to a non-parallel alignment. Holding jaw 70 is holding connector 210 loosely, enabling connector 210 to angularly float within holding jaw 70. Space 72 permits the angular alignment of cable connector 210 to change during the compression stroke so as to accommodate the toe-in of jaws 50 and 70, so that cable connector 210 remains axially self-aligned and also aligned with coaxial cable 200. The planes of ridges 82 and 84 are no longer parallel to the plane of face 74, while the plane of the end of compression sleeve 220 remains parallel to the plane of face 76. The compression force is thus applied generally axially along cable connector 210 throughout the compression stroke.

While the present invention has been described with reference to a particular preferred embodiment and the accompanying drawings, it will be understood by those skilled in the art that the invention is not limited to the preferred embodiment and that various modifications and the like could be made thereto without departing from the scope of the invention as defined in the following claims.

What is claimed is:

1. A compression tool for fitting a compression cable connector onto a coaxial cable, comprising:
two crosswise rotatably interconnected operating arms each having a handle at one end and a jaw at another end;
the jaws including engagement means for engaging and holding the cable connector in axial alignment with the cable such that the jaws are parallel to each other prior to a compression stroke of the compression tool and such that the cable connector angularly floats within one jaw during the compression stroke of the compression tool, thereby compressing the cable connector onto the coaxial cable in an axial direction of the cable connector.

2. A compression tool according to claim 1, wherein a space between a lip of one jaw and a ridge of the cable connector, when a cable connector is emplaced in said compression tool prior to the compression stroke, permits the cable connector to angularly float within one jaw during the compression stroke.

3. A compression tool for fitting a compression cable connector onto a coaxial cable, comprising:
first and second crosswise rotatably interconnected operating arms;
the first operating arm including a first handle at one end and a first jaw at another end;
the second operating arm including a second handle at one end and a second jaw at another end;
the first jaw including a first cavity sized to permit the coaxial cable to fit therethrough;
the second jaw including a second cavity and a lip around a part of the second cavity;
a space between the lip and a ridge of the cable connector;
the lip loosely holding a portion of the cable connector such that during a compression stroke of the compression tool, the space permits the cable connector to angularly float within the second jaw such that the first jaw compresses the cable connector onto the coaxial cable in an axial direction of the cable connector.

4. A compression tool according to claim 3, wherein the first and second cavities are horseshoe-shaped.

5. A method for making a compression tool for fitting a compression cable connector onto a coaxial cable, comprising the steps of:
making first and second operating arms, wherein the first operating arm includes a first handle at one end and a first jaw at another end, while the second operating arm includes a second handle at one end and a second jaw at another end, wherein the first jaw includes a first cavity sized to permit the coaxial cable to fit therethrough, while the second jaw includes a second cavity and a lip around part of the second cavity, wherein a space is formed between the lip and a ridge of the cable connector when the cable connector is fitted into the compression tool; with the lip loosely holding a portion of the cable connector such that during a compression stroke of the compression tool, the cable connector angularly floats within the second jaw such that the first jaw compresses the cable connector onto the coaxial cable in an axial direction of the cable connector; and
rotatably interconnecting the operating arms crosswise about a pivot point.

6. A method according to claim 4, wherein the first and second cavities are horseshoe-shaped.

7. A method for using a compression tool for fitting a compression cable connector onto a coaxial cable, comprising the steps of:
providing the compression tool wherein the compression tool includes two crosswise rotatably interconnected operating arms each having a handle at one end and a jaw at another end;
engaging and holding the cable connector between the jaws in axial alignment with the cable such that the jaws are parallel to each other prior to a compression stroke of the compression tool and a space is formed between a lip of one jaw and a ridge of the cable connector such that the cable connector angularly floats within one jaw during the compression stroke of the compression tool; and
compressing the cable connector onto the coaxial cable with the compression tool in an axial direction of the cable connector.
